(19) United States
(12) Patent Application Publication
(10) Pub. No.: US 2004/0182186 A1
(43) Pub. Date: Sep. 23, 2004

(54) Device for driving a gradient cable

(75) Inventor: Johann Fischer, Regen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Edscha Cabrio-Dachsysteme GmbH, Hengersberg (DE)

(21) Appl. No.: 10/664,648

(22) Filed: Sep. 19, 2003

(30) Foreign Application Priority Data
Mar. 20, 2003 (DE) 203 04 478.9

(51) Int. Cl. B60J 1/17; E06B 3/44

(52) U.S. Cl. 74/89.2; 49/352

(57) ABSTRACT

A device for driving a gradient cable includes a guide tube at least partly surrounding at least a section of the gradient cable, a housing supporting the gradient cable in its longitudinal direction, a driving pinion meshingly engaging with a first portion of the gradient cable, and a first guide wheel supporting the gradient cable at a level with the first portion of the gradient cable.

Priority is claimed to German Utility Model Application DE 203 04 478.9, filed on Mar. 20, 2003, the entire disclosure of which is incorporated by reference herein.

### BACKGROUND

The present invention relates to a device for driving a gradient cable, in particular to a device comprising a guide tube at least partly surrounding a section of the gradient cable, a housing supporting the gradient cable in its longitudinal direction and a driving pinion meshingly engaging with a portion of the gradient cable.

In the field of motor vehicle construction, the utilization of driven gradient cables is known for moving vehicle windows, which can be lowered or for opening and closing movable roof parts or other movable vehicle parts, such as flaps, etc. The term gradient cable includes designs, which are known as flexible longitudinal bodies, the outer circumference of which has spiral structures or other recurring structures in which a driving pinion can engage in a meshing manner in order to thereby transmit a force directed in the longitudinal direction of the gradient cable. Apart from the region of the meshing engagement of the driving pinion, the gradient cables are generally arranged in guide tubes, in which they can slide in a longitudinally displaceable manner. When gradient cables are utilized to transmit a movement, relatively high frictional forces are known to pose a problem. In particular, these forces occur in the region of the drive of the cables, which may result there in increased wear or, in an unfavorable situation, in a rupture.

German patent application DE 100 12 723, which is incorporated by reference herein, describes a driving device for gradient cables, in which an outgoing gradient cable and a returning gradient cable are operated at the same time using opposite sides of one driving pinion, wherein for achieving a better distribution of the driving forces two driving pinions are arranged one facing the other and are driven by means of a mutual central pinion. A device of this type already provides an improvement in the locally occurring maximum driving forces causing a risk of rupture, in comparison to a solution with just one driving pinion. Nevertheless, on the side lying opposite the meshing engagement of the driving pinions, the gradient cables continue to be subjected to a particularly high frictional force by the walls of the guide tubes, since the gradient cables are pressed there against the walls by a force that is proportional to the driving torque. This promotes premature wear of the gradient cables and of the tube or housing walls and brings a risk of rupture.

### SUMMARY OF THE INVENTION

It is an object of the present invention to provide a driving device for gradient cables, for which the transmission of force from the driving pinion to the gradient cable is improved.

It is a further or alternate object of the present invention to provide a driving device for gradient cables, which is more favorable with regard to the friction that occurs between the gradient cable and the walls of the housing.

It is another further or alternate object of the present invention to provide a driving device for gradient cables, which is less subject to failure due to the torque peaks that occur between the gradient cable and the walls of the housing.

It is yet another further or alternate object of the present invention to provide a driving device for gradient cables which is built in a simple manner.

The present invention provides a device for driving a gradient cable, the device comprising a guide tube at least partly surrounding at least a section of the gradient cable, a housing supporting the gradient cable in its longitudinal direction, a driving pinion meshingly engaging with a first portion of the gradient cable and a first guide wheel supporting the gradient cable at a level with the first portion of the gradient cable. As used herein, “at a level with the first portion of the gradient cable” means at essentially the same longitudinal position with respect to the first portion of the gradient cable.

The gradient cable according to the present invention experiences a rolling support by means of the guide wheel, as a result of which frictional forces occurring in the region of the drive, which would be caused by the gradient cable rubbing against the wall of the guide tube lying opposite the driving pinion, have been nearly completely avoided.

A preferred device advantageously comprises two gradient cables, the second gradient cable being correspondingly supported by means of a second guide wheel, and each of the two gradient cables being in each case assigned a guide tube portion on the inlet side and outlet side with respect to the driving pinion, so that a single driving pinion can be used simultaneously to drive two gradient cables. Devices of this type with a simultaneous drive of an incoming and outgoing gradient cable are suitable in particular for driving sliding roofs and movable roof parts of motor vehicles.

In a preferred embodiment of a device according to the present invention, the guide tube portion has a conical enlargement at an end, which faces the driving pinion. A conical or else funnel-shaped enlargement of this type effectively prevents the gradient cable from rubbing on or else tilting at the end of the guide tube.

The guide tube preferably has a supporting collar, the guide tube being supported in its longitudinal direction against the housing by means of a form-fitting engagement of the supporting collar in a corresponding recess in the housing. In addition, the housing advantageously comprises an upper and a lower housing half. This enables the device according to the present invention to be assembled in a simple manner from few components, the supporting collars of the guide tubes ensuring that the guide tubes are particularly securely held and precisely positioned on the housing.

The guide wheel is advantageously mounted in a sliding manner on the housing of a device according to the present invention by means of bearing bushings. In this case, the guide wheel is particularly advantageously also mounted on the housing by means of an adjustable bearing spindle, adjustment of the bearing spindle enabling the radial distance of the guide wheel from the driving pinion to be adjusted. This enables tolerances which occur in the production of a device according to the present invention in respect of the distances of the driving pinion and guide wheel and therefore in respect of the necessary, precise guidance of the gradient cable to be compensated in a simple manner.

The housing is preferably designed as a cast part, in particular as a die cast part or precision cast part or else as a worked part, in particular as a sheet-metal formed part, which enables the housing to be manufactured in large piece numbers at reasonable cost. As an alternative, however, the housing may also be designed as a construction part which is produced by means of metal-cutting machining, which enables particularly high precision to be achieved during production.

Further features and advantages of the device according to the present invention will emerge from the embodiment described below.

### BRIEF DESCRIPTION OF THE DRAWINGS

A preferred exemplary embodiment of a device according to the present invention is described below and explained in greater detail with reference to the attached drawings, in which:

FIG. 1 shows a plan view of a device according to the present invention from above;

FIG. 2 shows a plan view of the device according to the present invention from FIG. 1, an upper housing half being removed; and

FIG. 3 shows a schematic cross section through the device according to FIG. 1 along the line A-A, a driving unit being additionally mounted on the device.

### DETAILED DESCRIPTION OF A PREFERRED EMBODIMENT

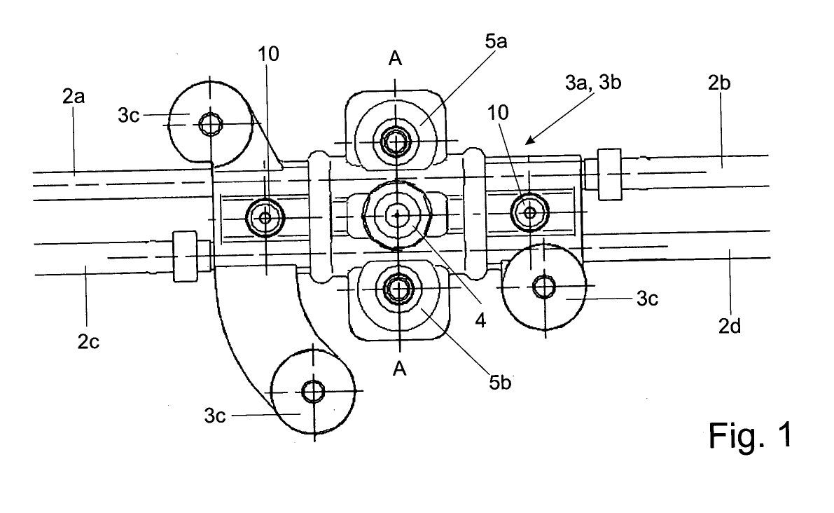

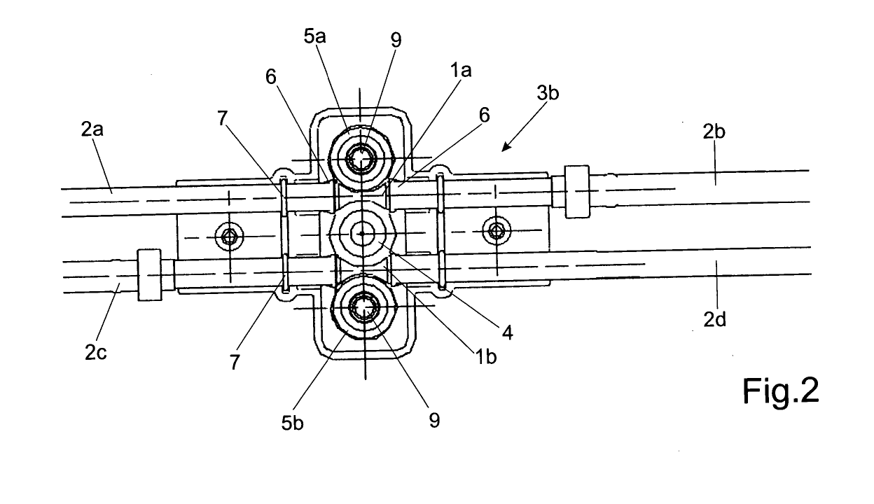

The device for driving a gradient cable shown in FIG. 1 comprises an upper housing half 3a and a lower housing half 3b, which are fixed to each other using screws 10. As is apparent in particular from FIG. 2, an incoming guide tube portion 2a and an outgoing guide tube portion 2b for a first gradient cable 1a and an incoming guide tube portion 2d and an outgoing guide tube portion 2c for a second gradient cable 1b are secured between the housing halves, supporting collars 7 which are formed on the guide tube portions 2a, 2b, 2c, 2d with guide tube portions 2a, 2b, 2c, 2d being used to provide a positioning and securing means which supports the guide tubes with guide tube portions 2a, 2b, 2c, 2d in the longitudinal direction. The supporting collars 7 engage in corresponding recesses on the housing halves 3a, 3b. A distance is left in each case between the proximal ends of the guide tube portions 2a, 2b and 2c, 2d, which are respectively assigned as left and right sides to the same gradient cable 1a, 1b, with the result that a driving pinion 4 including an inlet side and an outlet side can engage in a meshing manner in the gradient cables 1a, 1b which are exposed at these portions. The driving pinion 4 is arranged centrally in the housing 3a, 3b and is mounted in a rotatable manner with respect to the housing 3a, 3b by means of bearing 11.

Furthermore, retaining tabs 3c are provided with holes and are formed on the upper housing half 3a (see FIG. 1) and can be used to fix the device according to the present invention on a motor vehicle.

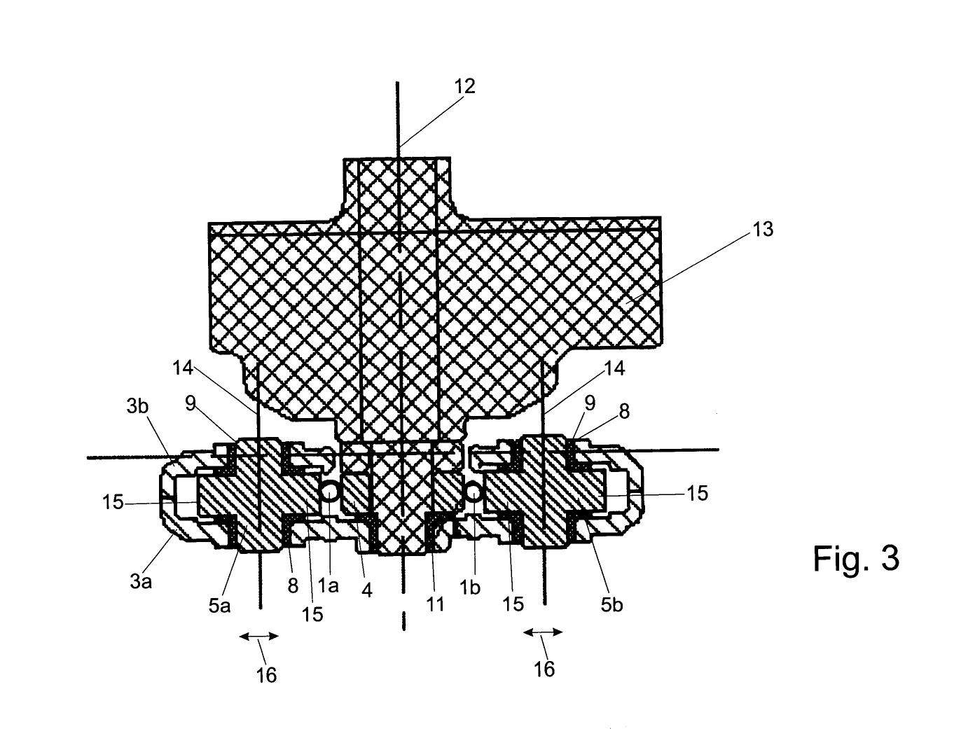

As shown in FIG. 3, the driving pinion 4 is connected by a shaft 12, which passes through the upper housing half 3a, to a driving unit 13, which may, for example, be an electric motor provided with a set of gears.

Furthermore, for each of the gradient cables 1a, 1b, a respective guide wheel 5a, 5b is received rotatably by means of bearing bushings 8 on the housing 3a, 3b, the guide wheels 5a, 5b supporting the gradient cables 1a, 1b with their respective central circular radial collar 15 in each case opposite the meshing engagement of the driving pinion 4. In the same manner as the driving pinion 4, the guide wheels 5a, 5b are provided with a tooting (not illustrated), such that the supporting force of the guide wheels 5a, 5b is not restricted to only the turns of the gradient cables 1a, 1b.

In order to prevent the gradient cables 1a, 1b from rubbing on or tilting at the ends of the guide tube portions 2a, 2b, 2c, 2d, the guide tubes with guide tube portions 2a, 2b, 2c, 2d are each provided with conical enlargements 6 on their sides proximal to the driving pinion.

The bearing spindles 9 of the guide wheels 5a, 5b are rotatable around a respective guide wheel axis 14 and can be adjusted by means of an eccentric, the adjustment of the bearing spindles 9 leading to a displacement (indicated by arrow 16) of the respective guide wheel 5a, 5b in a direction of the driving pinion 4 and to a change in the radial distance of the bearing spindle 9 with respect to the guide wheels 5a, 5b. This allows to correct for deviations from an exact positioning of the gradient cables 1a, 1b with respect to the guide tubes portions 2a, 2b, 2c, 2d due to production tolerances, such that an optimum guidance of the gradient cables 1a, 1b by the central circular radial collars 15 of the guide wheels 5a, 5b is achieved.

The present invention functions as follows:

The central driving pinion 4 is rotated clockwise with respect to FIG. 1 and FIG. 2 by means of the driving unit 13. The meshing engagement of the driving pinion 4 in the gradient cables 1a, 1b therefore causes the upper gradient cable 1a to be moved to the right and the lower gradient cable 1b to be moved to the left. Accordingly, the guide wheels 5a, 5b, which are assigned to the gradient cables 1a, 1b rotate anticlockwise at the same time.

A corresponding change in the direction of rotation of the drive shaft 12 or of the driving pinion 4 leads to a corresponding reversal of all of the movements, in which case the guide tubes 2a, 2b which were previously on the incoming side now become the guide tubes on the outgoing side, and vice versa.

What is claimed is:

1. A device for driving a first gradient cable, the device comprising;
a guide tube at least partly surrounding at least a section of the first gradient cable;
a housing supporting the first gradient cable in its longitudinal direction;
a driving pinion meshingly engaging with a first portion of the first gradient cable; and
a first guide wheel supporting the gradient cable at a level with the first portion of the first gradient cable.

2. The device as recited in claim 1, wherein the housing accommodates the first gradient cable, and wherein the first guide wheel is secured to the housing.

3. The device as recited in claim 1, further comprising a second gradient cable and a second guide wheel, the second gradient cable being driven by the driving pinion simultaneously with the first gradient cable, and the second guide wheel supporting the second gradient cable at the same level as the first guide wheel.

4. The device as recited in claim 3, wherein the driving pinion includes a first gradient cable inlet side, a first gradient cable outlet side, a second gradient cable inlet side, and a second gradient cable outlet side, and the device further comprises a first and a second guide tube portion at least partially surrounding the first gradient cable and disposed, respectively, at the first gradient cable inlet side and the first gradient cable outlet side, and wherein the device further comprises a third guide tube portion and a fourth guide tube portion at least partially surrounding the second gradient cable and disposed, respectively, at the second gradient cable inlet side and the second gradient cable outlet side.

5. The device as recited in claim 1, wherein the driving pinion includes an inlet side and an outlet side and wherein the first gradient cable is at least partly surrounded by a first guide tube portion disposed at the inlet side and by a second guide tube portion disposed at the outlet side.

6. The device as recited in claim 5, wherein at least one of the first guide tube portion and the second guide tube portion includes a conical enlargement at an end proximal to the driving pinion.

7. The device as recited in claim 1, wherein the guide tube includes a supporting collar disposed in form-fitting engagement in a recess in the housing and supporting the guide tube in a longitudinal direction.

8. The device as recited in claim 1, wherein the housing includes a bearing bushing for pivotably receiving the first guide wheel.

9. The device as recited in claim 8, wherein the first guide wheel includes a bearing spindle, defining a guide wheel axis and a central circular collar extending radially with respect to the bearing spindle, said central collar engaging the first gradient cable.

10. The device as recited in claim 1, wherein the first guide wheel includes a bearing spindle defining a guide wheel axis, and wherein the guide wheel axis is displaceable with respect to the driving pinion, such that a distance of the bearing spindle to the first guide wheel can be adjusted in response to a thickness of the first gradient cable.

11. The device as recited in claim 1, wherein the housing includes an upper housing half and a lower housing half.

12. The device as recited in claim 1, wherein the housing is selected from the group consisting of cast parts, die cast parts, precision cast parts, forming parts, sheet-metal formed parts and construction parts.
